(19) United States
(12) Patent Application Publication
(10) Pub. No.: US 2024/0265122 A1
(43) Pub. Date: Aug. 8, 2024

(54) SYSTEM AND METHOD FOR AUTHORIZING AN ACCESS TOKEN USING A DISTRIBUTED CACHE

(71) Applicant: RAKUTEN SYMPHONY SINGAPORE PTE. LTD., SINGAPORE (SG)

(72) Inventors: Manoj ASWANI, Indore (IN); Hemant SHARMA, indore (IN); Ayus KUMAR, Indore (IN); Shudhanshu SHEKHAR, Indore (IN); Arpit CHOUKSEY, Indore (IN)

(73) Assignee: RAKUTEN SYMPHONY SINGAPORE PTE. LTD., SINGAPORE (SG)

(21) Appl. No.: 18/012,038

(22) PCT Filed: Oct. 11, 2022
(86) PCT No.: PCT/US2022/046226

§ 371 Date: Dec. 21, 2022

(51) Int. Cl. G06F 21/62; G06F 21/64

(52) U.S. Cl. CPC G06F 21/62; G06F 21/64

(57) ABSTRACT

A method for authorizing a client application to access resources using a distributed cache is provided. The method includes: receiving, from the client application, a login request at an identity management (IDM) tool; providing, by the IDM tool to the distributed cache, a token session state of a first access token and permission information of the first access token; masking the permission information from the first access token and providing an updated access token to the client application with the permission information masked; receiving, at an application programming interface (API) gateway from the client application, a service request comprising the updated access token; validating the updated access token using the distributed cache; and providing a response to the client application based on the validation.

### BACKGROUND

### 1. Field

Apparatuses and methods consistent with example embodiments of the present disclosure relate to authorizing a user to access a system based on an access token. For example, an access token may be used to authorize an application to access specific resources on behalf of a user (e.g., OAuth2.0 protocol).

### 2. Description of Related Art

In related art, user token authorization is done with an identity management (IDM) access token using a gateway device.

An access token is used in OAuth2.0 to allow an application to access specific resources on behalf of a user. Although access tokens may be in the format of a JavaScript Object Notation (JSON) Web Token (JWT), they are not limited to this. If an access token corresponding to a client includes a lot of stored permissions, then a size of the access token becomes large. If the access token becomes large, an HTTP protocol violation may occur when transmitting the token to a gateway device.

### SUMMARY

According to embodiments, systems and methods are provided for authorizing a user access token by storing access token information in a distributed cache to reduce a size of the access token.

According to embodiments, a method, performed by at least one processor of a computing device, for authorizing a user access token by storing access token information in a distributed cache, includes: receiving, from the client application, a login request at an identity management (IDM) tool; providing, by the IDM tool to the distributed cache, a token session state of a first access token and permission information of the first access token; masking the permission information from the first access token and providing an updated access token to the client application with the permission information masked; receiving, at an application programming interface (API) gateway from the client application, a service request including the updated access token; validating the updated access token using the distributed cache; and providing a response to the client application based on the validation.

The validating the updated access token may further include determining that a token signature, a token expiration, and a token session state of the updated access token are valid.

The validating the updated access token may further include checking the permission information for the updated access token in the distributed cache in response to determining that the token signature, the token expiration, and the token session state of the access token are valid.

The providing the response to the client application may further include: in response to determining the permission information exists in the distributed cache, forwarding the service request to a microservice; and processing the service request at the microservice.

The processing the service request at the microservice may further include: identifying whether the microservice includes resources corresponding the service request; and providing a service response from the microservice to the API gateway based on the identifying.

The method may further include revoking the login request in response to determining that at least one of the token signature, the token expiration, and the token session state are invalid.

The method may further include sending an error message to the client application in response to determining that at least one of the token signature, the token expiration, and the token session state are invalid.

According to one or more embodiments, an apparatus for authorizing a client application to access resources using a distributed cache includes: a memory storing instructions; and at least one processor configured to execute the instructions to: receive, from the client application, a login request at an identity management (IDM) tool; provide, by the IDM tool to the distributed cache, a token session state of a first access token and permission information of the first access token; mask the permission information from the first access token and providing an updated access token to the client application with the permission information masked; receive, at an application programming interface (API) gateway from the client application, a service request including the updated access token; validate the updated access token using the distributed cache; and provide a response to the client application based on the validation.

The validating the updated access token may include determining that a token signature, a token expiration, and a token session state of the updated access token are valid.

The validating the updated access token may further include checking the permission information for the updated access token in the distributed cache in response to determining that the token signature, the token expiration, and the token session state of the access token are valid.

The providing the response to the client application may further include: in response to determining the permission information exists in the distributed cache, forwarding the service request to a microservice; and processing the service request at the microservice.

The at least one processor may be further configured to process the service request at the microservice to: identify whether the microservice includes resources corresponding the service request; and provide a service response from the microservice to the API gateway based on the identifying.

The at least one processor may be further configured to: revoke the login request in response to determining that at least one of the token signature, the token expiration, and the token session state are invalid.

The at least one processor may be further configured to send an error message to the client application in response to determining that at least one of the token signature, the token expiration, and the token session state are invalid.

According to one or more embodiments, a non-transitory computer-readable recording medium having recorded thereon instructions executable by at least one processor to perform a method of authorizing a client application to access resources using a distributed cache, the method may include: receiving, from the client application, a login request at an identity management (IDM) tool; providing, by the IDM tool to the distributed cache, a token session state of a first access token and permission information of the first access token; masking the permission information from the first access token and providing an updated access token to the client application with the permission information masked; receiving, at an application programming interface (API) gateway from the client application, a service request including the updated access token; validating the updated access token using the distributed cache; and providing a response to the client application based on the validation.

The validating the updated access token may include determining that a token signature, a token expiration, and a token session state of the updated access token are valid.

The validating the updated access token may further include checking the permission information for the updated access token in the distributed cache in response to determining that the token signature, the token expiration, and the token session state of the access token are valid.

The providing the response to the client application may further include: in response to determining the permission information exists in the distributed cache, forwarding the service request to a microservice; and processing the service request at the microservice.

The processing the service request at the microservice may include: identifying whether the microservice includes resources corresponding the service request; and providing a service response from the microservice to the API gateway based on the identifying.

The method may further include revoking the login request in response to determining that at least one of the token signature, the token expiration, and the token session state are invalid.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a flowchart of a method for authorizing a user access token by storing access token information in a distributed cache, according to an embodiment;

FIG. 2 illustrates a flowchart of a method for validating an access token received from a client application, according to an embodiment;

FIG. 3 illustrates a call flow diagram for authorizing an access token using a distributed cache, according to an embodiment;

FIG. 4 is a diagram of an example environment in which systems and/or methods, described herein, may be implemented; and

FIG. 5 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which a user access token is authorized by synchronizing an IDM tool and an application programming interface (API) gateway with a distributed cache. When a user/client logs in to an IDM tool, a token session state and the permissions for the user identified in the access token are sent to and stored in a distributed cache. Regarding the permissions stored in the access token, if the access token includes many permissions, the size of the access token becomes large and may cause an error (e.g., HTTP protocol violation) when transmitting the access token to an API gateway. According to example embodiments, the permissions are stored in a distributed cache and the access token is returned to the client with the permissions masked from the access token. Thus, a size of the access token is reduced, thereby reducing a likelihood that an error may occur when the access token is transmitted from the client to the API gateway. Because the access token does not include the permissions, the API gateway communicates with a distributed cache to check whether the permissions are valid for the client.

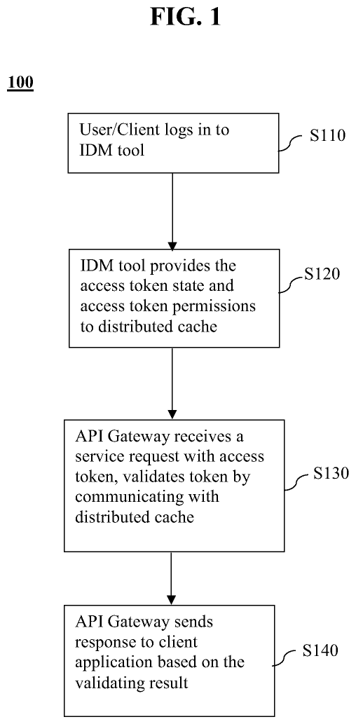

FIG. 1 illustrates a flowchart of a method 100 for authorizing a user access token by storing access token information in a distributed cache, according to an embodiment. The method 100 of FIG. 1 may be performed by at least one processor executing instructions stored in at least one memory.

Referring to FIG. 1, at operation S110, a user of a client application logs in to an identity management (IDM) tool. At operation S120, the IDM tool sends an access token for the client application to a distributed cache. The access token may include token session state information and permissions for the user and/or client application. The token session state information and permissions may be stored at the distributed cache. The permissions may then be masked from the access token and the access token may be returned to the client application. Masking the permissions reduces the size of the access token to reduce a likelihood of an error (e.g., an HTTP protocol violation) being caused when sending the access token to an application programming interface (API) gateway.

At operation S130, the API gateway receives a request from a client application with an access token. The access token received by the API gateway does not include the permissions for the client application. The API gateway checks the signature and the expiration for the access token. As described above, the permissions and token session state for the access token are stored in the distributed cache. Thus, the API gateway communicates with the distributed cache to check the token session state and permissions for the access token. If the permissions are validated, then a service request is forwarded to an application or microservice, resulting in a response received at the API gateway from the application or microservice.

At operation S140, the API gateway forwards a response to the client application. If the access token was found to be valid by the API gateway, the response received at the client application will be a service response corresponding to the application or microservice. If the access token is found to be invalid, the response received at the client application will be a revocation of access to the API gateway.

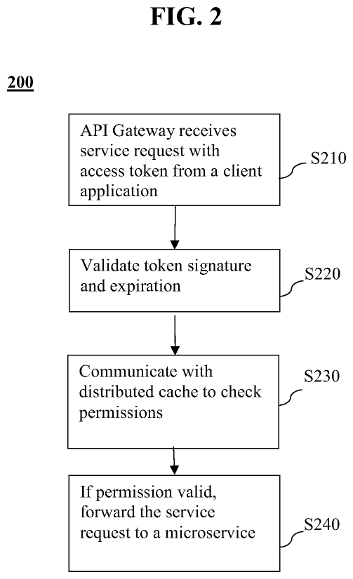

FIG. 2 illustrates a flowchart of a method 200 for validating an access token received from a client application, according to an embodiment. The method 200 of FIG. 2 may correspond to operation S130 shown in FIG. 1. Further, the method 200 of FIG. 2 may be performed by at least one processor executing instructions stored in at least one memory.

At operation S210, the API gateway receives a request from a client application with an access token with the permissions masked. At operation S220, the API gateway checks the access token signature and expiration to confirm their validity. If the token signature or expiration are invalid, the API gateway sends a response to the client application revoking its access to the API gateway.

At operation S230, the API gateway communicates with a distributed cache to check the permissions for the client application. The permissions are stored in the distributed cache to reduce a size of the access token to reduce a likelihood of receiving an HTTP protocol error. At operation S240, if the permissions are valid, then the API gateway forwards a service request to the application or microservice.

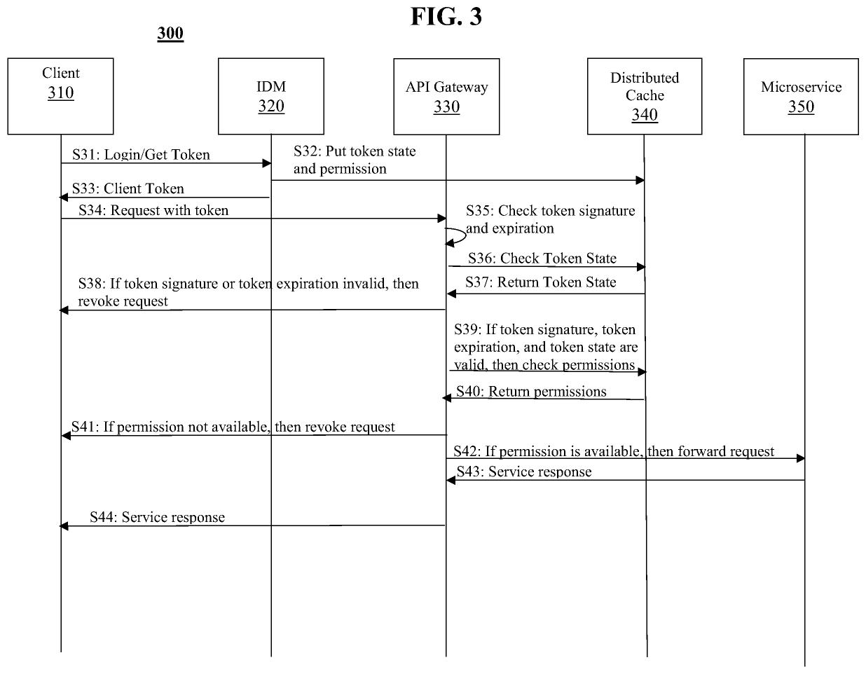

FIG. 3 illustrates a call flow diagram 300 for authorizing an access token using a distributed cache 340, according to an embodiment. The operations shown in FIG. 3 may be performed by at least one processor executing instructions stored in at least one memory.

Referring to FIG. 3, at S31, a user, using a client application 310, logs in to an IDM tool 320. For example, the client application 310 may transmit the user's login request to the IDM tool 320 and upon validation of the user's credentials, the IDM tool 320 may transmit an access token in a specific format to the client 310. In embodiments wherein a specific tenant is considered, the access token may include the user's role associated with the specific tenant. The IDM tool 320 may send the access token corresponding to the client application to a distributed cache 340. The distributed cache 340 stores a token session state and permissions for the access token. The access token may be used to access APIs from the API gateway. The access token may be in the format of a JWT. However, access tokens are not limited to JWTs, and may be in many other formats.

At S32, the access token session state and permissions are sent to and stored in the distributed cache 340. According to embodiments, the access token may be in a first format and may include a mapping of permissions associated with the user, the mapping of permissions associated with the user based on the mapping of roles associated with the user and the security context for the user. With the increasing complexity of the systems, a user may have a plurality of roles, each with varying permissions, for one or more tenants of a multi-tenant system. As an example, a user may have a system admin role for a first tenant, a tenant admin for the second tenant, and a tenant user for a third tenant.

At S33, the access token is returned to the client 310 from the IDM tool 320 with the permissions masked. The permissions are masked to reduce a size of the access token. Once generated, the access token may be used for subsequent requests to the microservices and APIs. At S34, a service request with the access token is sent from the client 310 to the API gateway 330. The service request may include one or more request parameters.

At S35, the API gateway 330 receives the access token access token and confirms that the access token is a valid token. For example, the API gateway 330 checks to make sure the access token includes a valid signature and checks the expiration date of the access token. If either the signature is invalid or the expiration date is invalid, the service request is revoked and an error message is returned to the client 310.

At S36, if it is determined that the signature is valid and the expiration date is valid, then the API gateway 330 communicates with the distributed cache 340 to fetch the token session state and permissions of the access token.

At S37, the token session state and permissions of the access token are returned to the API gateway 330. At S38, if it is determined that any one of the token signature, the token expiration of the access token, and the token session state are invalid, then the service request is revoked. A gateway revoke response will be sent by the API gateway 330 to the client 310.

At S39, if it is determined that the token signature, the token expiration, and the token session state of the access token are valid, then the permissions are checked with the distributed cache 340. At S40, the permissions for the access token are returned to the API gateway.

At S41, if permissions do not exist, then the request is revoked, and a gateway revoke response is sent to the client 310. At S42, if permission is available, then the service request is forwarded to an application or microservice 350. At S43, the application or microservice 350 provides a service response to the API gateway 330. At S44, the service response is provided to the client device 310 by the API gateway 330.

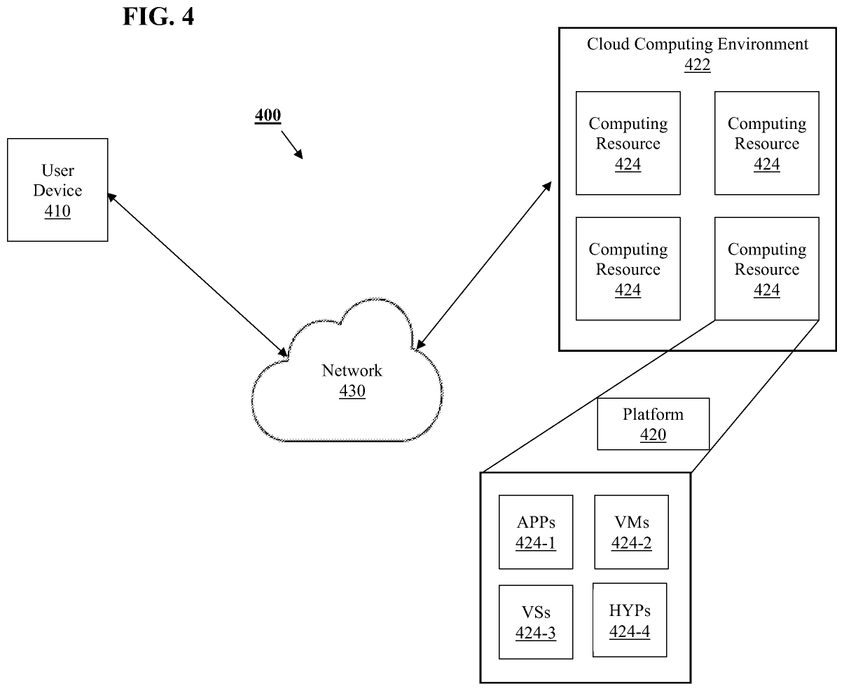

FIG. 4 is a diagram of an example environment 400 in which systems and/or methods, described herein, may be implemented. As shown in FIG. 4, environment 400 may include a user device 410, a platform 420, and a network 430. Devices of environment 400 may interconnect via wired connections, wireless connections, or a combination of wired and wireless connections. In embodiments, any of the functions and operations described with reference to FIG. 1 above may be performed by any combination of elements illustrated in FIG. 4.

User device 410 includes one or more devices capable of receiving, generating, storing, processing, and/or providing information associated with platform 420. For example, user device 410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 410 may receive information from and/or transmit information to platform 420.

Platform 420 includes one or more devices capable of receiving, generating, storing, processing, and/or providing information. In some implementations, platform 420 may include a cloud server or a group of cloud servers. In some implementations, platform 420 may be designed to be modular such that certain software components may be swapped in or out depending on a particular need. As such, platform 420 may be easily and/or quickly reconfigured for different uses.

In some implementations, as shown, platform 420 may be hosted in cloud computing environment 422. Notably, while implementations described herein describe platform 420 as being hosted in cloud computing environment 422, in some implementations, platform 420 may not be cloud-based (i.e., may be implemented outside of a cloud computing environment) or may be partially cloud-based.

Cloud computing environment 422 includes an environment that hosts platform 420. Cloud computing environment 422 may provide computation, software, data access, storage, etc., services that do not require end-user (e.g., user device 410) knowledge of a physical location and configuration of system(s) and/or device(s) that hosts platform 420. As shown, cloud computing environment 422 may include a group of computing resources 424 (referred to collectively as “computing resources 424” and individually as “computing resource 424”).

Computing resource 424 includes one or more personal computers, a cluster of computing devices, workstation computers, server devices, or other types of computation and/or communication devices. In some implementations, computing resource 424 may host platform 420. The cloud resources may include compute instances executing in computing resource 424, storage devices provided in computing resource 424, data transfer devices provided by computing resource 424, etc. In some implementations, computing resource 424 may communicate with other computing resources 424 via wired connections, wireless connections, or a combination of wired and wireless connections.

As further shown in FIG. 4, computing resource 424 includes a group of cloud resources, such as one or more applications (“APPs”) 424-1, one or more virtual machines (“VMs”) 424-2, virtualized storage (“VSs”) 424-3, one or more hypervisors (“HYPs”) 424-4, or the like.

Application 424-1 includes one or more software applications that may be provided to or accessed by user device 410. Application 424-1 may eliminate a need to install and execute the software applications on user device 410. For example, application 424-1 may include software associated with platform 420 and/or any other software capable of being provided via cloud computing environment 422. In some implementations, one application 424-1 may send/receive information to/from one or more other applications 424-1, via virtual machine 424-2.

Virtual machine 424-2 includes a software implementation of a machine (e.g., a computer) that executes programs like a physical machine. Virtual machine 424-2 may be either a system virtual machine or a process virtual machine, depending upon use and degree of correspondence to any real machine by virtual machine 424-2. A system virtual machine may provide a complete system platform that supports execution of a complete operating system (“OS”). A process virtual machine may execute a single program, and may support a single process. In some implementations, virtual machine 424-2 may execute on behalf of a user (e.g., user device 410), and may manage infrastructure of cloud computing environment 422, such as data management, synchronization, or long-duration data transfers.

Virtualized storage 424-3 includes one or more storage systems and/or one or more devices that use virtualization techniques within the storage systems or devices of computing resource 424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 424-4 may provide hardware virtualization techniques that allow multiple operating systems (e.g., “guest operating systems”) to execute concurrently on a host computer, such as computing resource 424. Hypervisor 424-4 may present a virtual operating platform to the guest operating systems, and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

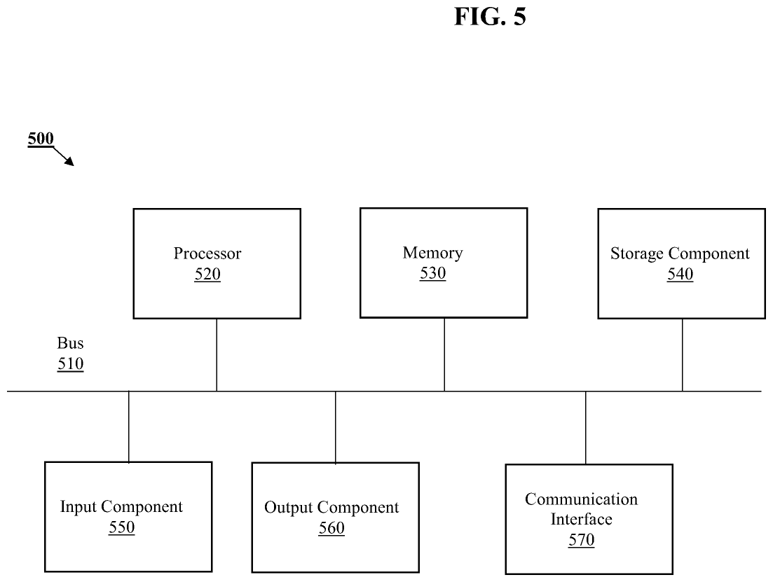

FIG. 5 is a diagram of example components of a device 500. Device 500 may correspond to user device 410 and/or platform 420. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 may be implemented in hardware, firmware, or a combination of hardware and software. Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

Device 500 may perform one or more processes described herein. Device 500 may perform these processes in response to processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

In embodiments, any one of the operations or processes of FIGS. 1, 2, and 3 may be implemented by or using any one of the elements illustrated in FIGS. 4 and 5.

According to example embodiments, IDM and gateway tools are integrated with a distributed cache when a user logs in the IDM will place a token session state and permissions in a distributed cache. Then, when an access token is used the gateway will authorize permissions using a distributed cache. As a result, the size of the access token will not increase with the number of permissions. Further, because the size of the access token is not increased, an HTTP protocol violation will not occur.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method, performed by at least one processor, for authorizing a client application to access resources using a distributed cache, the method comprising:
receiving, from the client application, a login request at an identity management (IDM) tool;
providing, by the IDM tool to the distributed cache, a token session state of a first access token and permission information of the first access token;
masking the permission information from the first access token and providing an updated access token to the client application with the permission information masked;
receiving, at an application programming interface (API) gateway from the client application, a service request comprising the updated access token;
validating the updated access token using the distributed cache; and
providing a response to the client application based on the validation.

2. The method of claim 1, wherein the validating the updated access token comprises determining that a token signature, a token expiration, and a token session state of the updated access token are valid.

3. The method of claim 2, wherein the validating the updated access token further comprises checking the permission information for the updated access token in the distributed cache in response to determining that the token signature, the token expiration, and the token session state of the access token are valid.

4. The method of claim 1, wherein the providing the response to the client application comprises:
in response to determining the permission information exists in the distributed cache, forwarding the service request to a microservice; and
processing the service request at the microservice.

5. The method of claim 4, wherein the processing the service request at the microservice comprises:
identifying whether the microservice comprises resources corresponding the service request; and
providing a service response from the microservice to the API gateway based on the identifying.

6. The method of claim 1, further comprising:
revoking the login request in response to determining that at least one of the token signature, the token expiration, and the token session state are invalid.

7. The method of claim 6, further comprising sending an error message to the client application in response to determining that at least one of the token signature, the token expiration, and the token session state are invalid.

8. An apparatus for authorizing a client application to access resources using a distributed cache, the apparatus comprising:
a memory storing instructions; and
at least one processor configured to execute the instructions to:
receive, from the client application, a login request at an identity management (IDM) tool;
provide, by the IDM tool to the distributed cache, a token session state of a first access token and permission information of the first access token;
mask the permission information from the first access token and providing an updated access token to the client application with the permission information masked;
receive, at an application programming interface (API) gateway from the client application, a service request comprising the updated access token;
validate the updated access token using the distributed cache; and
provide a response to the client application based on the validation.

9. The apparatus of claim 8, wherein the validating the updated access token comprises determining that a token signature, a token expiration, and a token session state of the updated access token are valid.

10. The apparatus of claim 9, wherein the validating the updated access token further comprises checking the permission information for the updated access token in the distributed cache in response to determining that the token signature, the token expiration, and the token session state of the access token are valid.

11. The apparatus of claim 8, wherein the providing the response to the client application comprises:
in response to determining the permission information exists in the distributed cache, forwarding the service request to a microservice; and
processing the service request at the microservice.

12. The apparatus of claim 11, wherein the at least one processor is further configured to process the service request at the microservice to:
identify whether the microservice comprises resources corresponding the service request; and
provide a service response from the microservice to the API gateway based on the identifying.

13. The apparatus of claim 8, wherein the at least one processor is further configured to:
revoke the login request in response to determining that at least one of the token signature, the token expiration, and the token session state are invalid.

14. The apparatus of claim 13, wherein the at least one processor is further configured to send an error message to the client application in response to determining that at least one of the token signature, the token expiration, and the token session state are invalid.

15. A non-transitory computer-readable recording medium having recorded thereon instructions executable by at least one processor to perform a method of authorizing a client application to access resources using a distributed cache, the method comprising:
receiving, from the client application, a login request at an identity management (IDM) tool;
providing, by the IDM tool to the distributed cache, a token session state of a first access token and permission information of the first access token;
masking the permission information from the first access token and providing an updated access token to the client application with the permission information masked;
receiving, at an application programming interface (API) gateway from the client application, a service request comprising the updated access token;
validating the updated access token using the distributed cache; and
providing a response to the client application based on the validation.

16. The non-transitory computer-readable recording medium as claimed in claim 15, wherein the validating the updated access token comprises determining that a token signature, a token expiration, and a token session state of the updated access token are valid.

17. The non-transitory computer-readable recording medium as claimed in claim 16, wherein the validating the updated access token further comprises checking the permission information for the updated access token in the distributed cache in response to determining that the token signature, the token expiration, and the token session state of the access token are valid.

18. The non-transitory computer-readable recording medium as claimed in claim 15, wherein the providing the response to the client application comprises:
in response to determining the permission information exists in the distributed cache, forwarding the service request to a microservice; and
processing the service request at the microservice.

19. The non-transitory computer-readable recording medium as claimed in claim 18, wherein the processing the service request at the microservice comprises:
identifying whether the microservice comprises resources corresponding the service request; and
providing a service response from the microservice to the API gateway based on the identifying.

20. The non-transitory computer-readable recording medium as claimed in claim 15, further comprising:
revoking the login request in response to determining that at least one of the token signature, the token expiration, and the token session state are invalid.
